(19) United States
(12) Patent Application Publication
(10) Pub. No.: US 2011/0011381 A1
(43) Pub. Date: Jan. 20, 2011

(54) Internal combustion engine and method for adapting an internal combustion engine

(75) Inventor: Erwin Erik Paul Georges Vandenberghe, Dessel (BE)

Correspondence Address: KNOBBE MARTENS OLSON & BEAR LLP, 2040 MAIN STREET, FOURTEENTH FLOOR, IRVINE, CA, 92614, US

(73) Assignees: HYDROGEN ENGINE NV, Leuven (BE); HYTECHNICS BVBA, Dessel (BE)

(21) Appl. No.: 12/810,506

(22) PCT Filed: Dec. 19, 2008
(86) PCT No.: PCT/BE2008/000102

§ 371 Date: Sep. 29, 2010

(30) Foreign Application Priority Data
Dec. 24, 2007 (BE) 2007/0619

(51) Int. Cl. F02B 13/00; F02M 37/00

(52) U.S. Cl. 123/575; 123/434

(57) ABSTRACT

An internal combustion engine of the four- stroke combustion engine type is disclosed, comprising an engine block provided with at least one cylinder (2) having a piston movable reciprocally therein for the purpose of bounding a combustion chamber, feed means for air (3) debouching in the combustion chamber, feed means for fuel (4) debouching in the combustion chamber, discharge means for combustion gases (5) connected to the combustion chamber and an ignition mechanism, wherein at least two inlet valves (6,7) and at least one outlet valve (8) are arranged per cylinder, wherein the feed means for air (3) are connected to the one inlet valve (7), the air inlet valve, the feed means for a first fuel (4) are connected to the other inlet valve (6), the fuel inlet valve, and that it is arranged in order to allow mixing of first fuel and air only inside the combustion chamber during operation. Also an adaptation method is disclosed for an engine.

A first aspect of the present invention relates to an internal combustion engine, comprising an engine block provided with at least one cylinder having a piston movable reciprocally therein for the purpose of bounding a combustion chamber, feed means for air debouching in the combustion chamber, feed means for fuel debouching in the combustion chamber, discharge means for combustion gases connected to the combustion chamber and an ignition mechanism, wherein at least two inlet valves and at least one outlet valve are arranged per cylinder.

The use of liquid fuels to drive internal combustion engines is generally known. In addition, internal combustion engines also exist which operate on gaseous fuels. Different systems have further already been proposed for driving combustion engines by means of hydrogen gas. The hydrogen gas can herein be fed to the cylinder directly (direct injection) or indirectly (via injectors in the inlet manifold). A number of significant drawbacks are however associated with the known systems.

Since hydrogen is a very volatile substance many problems can occur, for instance leaking injectors and a high susceptibility to backfire problems. Backfire problems can occur due to a premature combustion of an air-fuel mixture in the inlet system of the engine, and can often be attributed to residual mixture in the inlet collector as a consequence of, among other factors, leaking injectors, wear of the engine and its components or spontaneous ignition of the mixture due to hot carbon particles in the combustion space. It will be apparent that this undesirable combustion can result in considerable damage to various engine components. In addition, the known systems operating on gaseous fuels provide inferior performance in respect of power and efficiency. This is caused mainly by the limited amount of hydrogen which can be added during the inlet stroke. In the case of petrol a percentage between about 0.6% by volume and about 8% by volume of petrol must be added to the inlet air in order to achieve a combustible mixture. In the case of hydrogen this quantity amounts to between about 5% by volume and about 75% by volume. The speed at which hydrogen is diffused into the air is also much higher than for petrol vapour, natural gas (comprising or consisting substantially or consisting of CH4) or LPG.

Embodiments of the present invention have for its object to solve the above stated problems by providing an internal combustion engine, preferably of the four-stroke combustion engine type, which is distinguished from the combustion engine referred to in the preamble in that the feed means for air are connected to the one inlet valve, said air inlet valve, and the feed means for a first fuel are connected to the other inlet valve, said fuel inlet valve. The air and the first fuel, preferably hydrogen, are here thus fed separately to the combustion chamber, and mixing of the air with this fuel consequently takes place only in the combustion chamber and not in the inlet manifold as in the case of indirect injection. In other words the mixing of air (or oxygen) with the first fuel does not take place outside the combustion chamber. In still other words, the first fuel thus does not comprise oxygen or air before entering the combustion chamber.

According to preferred embodiments of the present invention, the engine is thus arranged in order to allow mixing of first fuel and air (or oxigen) only inside the combustion chamber during operation.

Furthermore, the problem of leaking injectors is also solved in that the feed of the fuel to the combustion chamber is also regulated by an inlet valve.

According to preferred embodiments of the present invention, the ignition mechanism can comprise at least one spark plug.

According to preferred embodiment of the present invention the engine comprises 4 valves, of which 2 are inlet valves and 2 are outlet valves. According to further embodiments of the present invention the engine comprises 5 valves, of which at least one valve is an inlet valve for a first fuel and at least one valve, is an inlet valve for air (or oxygen).

According to a further development of the device according to the present invention, the air inlet valve and the fuel inlet valve are separately controlled. The valves can hereby have different opening times, and the opening times can be adjusted to each other during operation of the combustion engine in accordance with a preferred method. The air inlet valve will preferably be opened only during the inlet stroke of the combustion engine so that the cylinder is cooled, after which the fuel inlet valve is opened.

According to embodiments of the present invention, the inlet valves can preferably be coupled to a camshaft. Also the outlet valves can preferably be coupled to the camshaft. Preferably all valves are coupled to the camshaft.

According to yet another development of the device according to the present invention, the feed means for feeding the first fuel to the combustion chamber can be provided with a fuel compartment which is closable by means of the fuel inlet valve.

According to preferred embodiments of the present invention, the fuel compartment can further comprise a pressure sensor. This pressure sensor can be connected with an engine control means, which can be adapted for controlling the operation of the engine. The presence of the pressure sensor in the fuel compartment (and the communication with the engine control means) is expected to allow for an dynamic optimization of the engine's working conditions (as there are for instance power, consumption, etc.).

According to yet another development of the device according to the present invention, a connecting channel closable by means of a valve can be provided between the fuel compartment and an air compartment closable by the air inlet valve, this air compartment being connected to the feed means for air. This connecting channel enables flushing of the fuel inlet with air.

In yet another further development of the internal combustion engine according to the present invention the fuel compartment is connected to a carburettor system or an injector.

In further developed embodiments according to the present invention feed means for an additional second fuel can further also be provided. The feed means for the second fuel can herein be connected to the feed means for air. This second fuel is preferably a liquid or gaseous fuel, such as for instance petrol, natural gas, LPG. The engine can herein operate in bi-fuel mode, i.e. on the first and/or the second fuel, if the first fuel or the second fuel is for instance not available for fuelling.

The connecting channel is opened permanently in the case of an engine which still operates on the additional second fuel, such as for instance petrol, the injector(s) of which is disposed centrally, so that when this engine is operating on the second fuel an already formed fuel mixture can be fed via the two inlet valves per cylinder into the combustion chamber(s) of the engine during the inlet stroke. During operation on hydrogen this valve can optionally remain closed and only be opened during flushing of the fuel compartment with air.

In a further embodiment according to the present invention means can also be provided which, when both fuels are introduced into the combustion space, allow determined quantities of the first and the second fuel to be mixed in the combustion chamber, for instance a fixed percentage of the first fuel to be mixed in the combustion chamber with the second fuel. The connecting valve preferably remains closed here and both fuels are supplied separately to the combustion space.

In an alternative embodiment according to the present invention feed means for the second fuel can also be provided, which feed means comprise means for direct injection of this second fuel into the combustion chamber. The first fuel can herein be added to the combustion chamber via the fuel inlet valve, the air can be introduced via the air inlet valve and the second fuel can be injected directly (direct injection, for instance petrol or diesel) into the combustion chamber.

In alternative embodiments according to the present invention the air can be fed to the combustion chamber under increased pressure, for instance by making use of a turbo or compressor connected to the feed means for air, wherein the air can possibly be injected directly into the combustion chamber by making use of an air injector. The ratio of fuel and air can hereby be finely adjusted, and an immediate change in injection strategy is possible. This will increase the efficiency of the engine.

The internal combustion engine according to embodiments of the present invention is particularly suitable for hydrogen as first fuel. In addition, the combustion engine according to the present invention could also be used for other gaseous fuels as first fuel, such as for instance natural gas, LPG and so on. In preferred embodiments of the present invention, the first fuel can comprise hydrogen. It can comprise more than 40%, more than 50%, more than 60%, more than 70 80%, more than 90%, more than 95%, more than 99%, more than 99.9%, more than 99.99% hydrogen. It may substantially consist of hydrogen or consist of hydrogen. The fuel comprising hydrogen may further comprise other components.

According to embodiments of the present invention, the first fuel may comprise natural gas (CH₄). It can comprise more than 40%, more than 50%, more than 60%, more than 70, 80%, more than 90%, more than 95%, more than 99%, more than 99.9%, more than 99.99% natural gas. It may substantially consist of natural gas or consist of natural gas. The fuel comprising natural gas may further comprise other components.

According to embodiments of the present invention, the first fuel may comprise a mix of hydrogen and natural gas. It may comprise a mix of substantially only hydrogen and natural gas. It may comprise a mic of only hydrogen and natural gas. The mix of hydrogen and natural gas can advantageously comprise at least 40% of hydrogen.

In particular preferred embodiments of the engine according to the present invention an additional second fuel can further also be used to operate the engine in addition to the first fuel. This second fuel is preferably liquid or gaseous, for instance petrol, diesel, natural gas, LPG and so on.

It is an advantage of the present invention that this system can be applied in simple manner in engines which operate in accordance with the Otto cycle or diesel cycle, and the cylinders of which are each provided with at least two inlet valves. The general engine configuration of a normal internal combustion engine can be retained, since it is substantially only the inlet system that is modified. An existing inlet valve can for instance be used as fuel inlet valve. The internal combustion engine according to embodiments of the present invention is particularly suitable for gaseous fuels, in particular hydrogen.

It is a further advantage of embodiments of the present invention that the injectors for the first fuel, preferably hydrogen, need less frequent replacement than in the case of the known combustion engines operating on hydrogen. The combustion engine according to the present invention can moreover achieve a greater power than the known hydrogen engines.

According to a second aspect of the present invention, a method is disclosed for adapting a four-stroke engine, which comprises an engine block provided with at least one cylinder having a piston movable reciprocally therein for the purpose of bounding (or confining) a combustion chamber, feed means for air debouching in the combustion chamber, feed means for fuel debouching in the combustion chamber, discharge means for combustion gases connected to the combustion chamber and an ignition mechanism, wherein at least two inlet valves and at least one outlet valve are arranged per cylinder, comprising:
arranging the engine in order to have the feed means for air connected to the first inlet valve, and to have the feed means for a first fuel connected to the second inlet valve;
arranging the engine in order to allow mixing of the first fuel and air (or oxygen) (or the air, or the oxigen) only inside the combustion chamber during operation.

In preferred embodiments the not allowing of the mixing of the first fuel and the air is achieved by rearranging the coupling of at least the inlet valves with the camshaft.

In preferred embodiments of the second aspect of the present invention, a fuel compartment for the first fuel may further be provided.

In preferred embodiments of the second aspect of the present invention, the fuel compartment may further be provided with a pressure sensor. The pressure sensor may further be connected with an engine controle means. The method is advantageously applicable to adapt a common 4-stroke petrol engine for use with hydrogen as a first fuel.

The invention will be further described with reference to the accompanying figures which show in schematic manner preferred embodiments which are not in any way intended to limit the scope of protection of the claims, and in which:

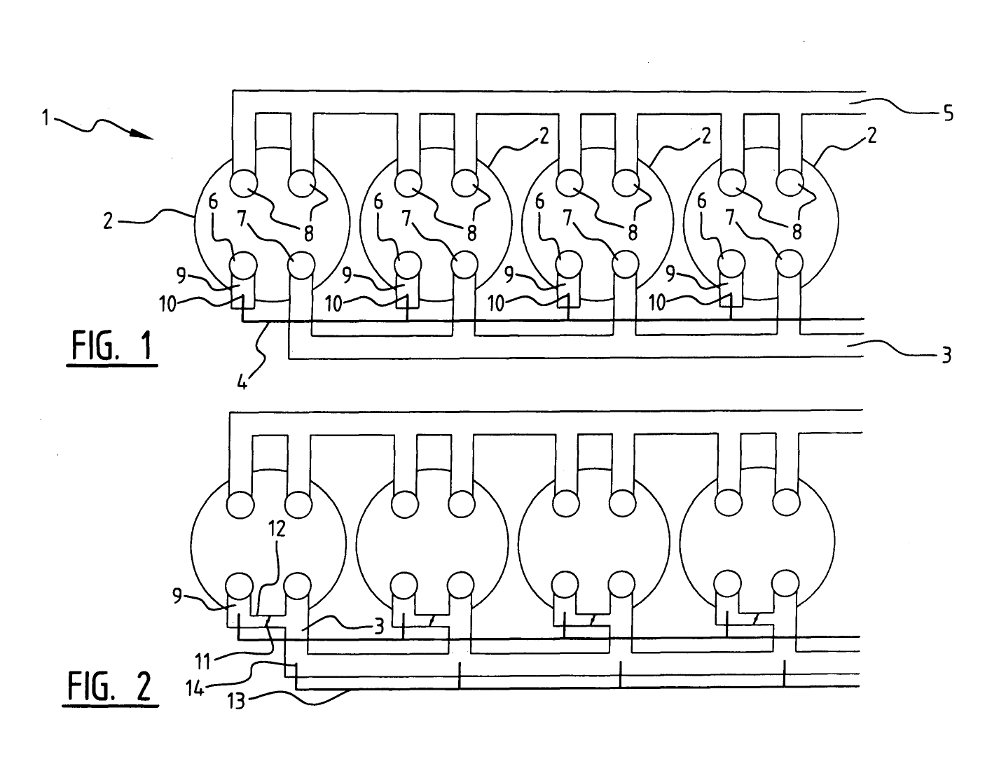

FIG. 1 shows a simplified diagram of an engine block of a preferred embodiment according to the present invention;

FIG. 2 shows a simplified diagram of an engine block of a further preferred embodiment according to the present invention.

FIG. 1 shows a highly simplified diagram of an engine block 1 according to a preferred embodiment of the present invention, comprising four cylinders 2 and further feed means for air comprising an air inlet 3, a feed conduit 4 for a first fuel, and discharge means for combustion gases comprising an outlet 5. Each cylinder is further provided with two inlet valves 6, 7 and two outlet valves 8. As shown in FIG. 1, the fuel inlet valve 6 closes off a fuel compartment 9, this fuel compartment being supplied by an injector 10. Air inlet valve 7 further closes air inlet 3, and outlet valves 8 are provided for the purpose of closing outlet 5.

It will be apparent from FIG. 1 that the supply of the air and the fuel to cylinders 2 takes place completely separately. The mixing of the air and the (first) fuel thereby takes place only in the combustion chamber of the cylinder. This works particularly well in the case of gaseous fuels, and particularly hydrogen gas, which due to its low molecular weight can diffuse very rapidly in the cylinder when fuel inlet valve 6 is opened. Because the feed of the air and the fuel to the combustion chamber takes place completely separately, and the fuel feed to the cylinder is moreover controlled by an inlet valve, the problem of leaking injectors is avoided as well as the backfire problems possibly related thereto.

In the embodiment according to FIG. 1 fuel compartment 9 is supplied by an injector 10. In addition, fuel compartment 9 can for instance also be supplied by a carburettor system.

The inlet valves are preferably controlled separately by a distribution system for the valves, and the valves have different opening times. An advantageous method for controlling the valves is as follows: in a first step the air inlet valve 7 is opened, wherein cooling is in this way also provided; in a second step the fuel inlet valve 6 is opened, wherein the fuel is fed to the combustion chamber, preferably under light overpressure. Other suitable methods for controlling the valves are possible.

FIG. 2 shows in simplified schematic manner a further developed preferred embodiment according to the present invention, wherein a connecting channel 12 closable by means of a valve 11 is provided between air inlet 3 and fuel compartment 9. In specific conditions this valve 11 can be opened, for instance for flushing the fuel inlet, or remain permanently open when the engine is a bi-fuel engine which is operating at that moment on the other second fuel instead of the first fuel hydrogen.

In the embodiment according to FIG. 2 a feed conduit 13 for an additional second fuel is also shown. This second fuel is preferably injected into air inlet 3 by means of injectors 14 and fed via the air inlet to the cylinders.

According to an alternative embodiment (not shown) an injector connected to the feed means for the air can be provided per cylinder, whereby the air can be injected directly into the combustion chamber.

According to another alternative embodiment (not shown) feed means for a second fuel can be provided per cylinder which comprise means for direct injection of this second fuel into the combustion chamber. The second fuel can herein be injected directly under high pressure into the combustion space, preferably when the first fuel has already been added to the inlet air in the combustion chamber via the fuel inlet valve.

The description of aspects of the present invention is performed by means of particular embodiments and with reference to certain drawings but the invention is not limited thereto. Depicted figures are only schematic and should not be considered as limiting. E.g. certain elements or features may be shown out of proportion or out of scale with respect to other elements.

In the description of certain embodiments according to the present invention, various features are sometimes grouped together in a single embodiment, figure, or description thereof for the purpose of aiding in the understanding of one or more of the various inventive aspects. This is not to be interpreted as if all features of the group are necessarily present to solve a particular problem. Inventive aspects may lie in less than all features of such a group of features present in the description of a particular embodiment.

While some embodiments described herein include some but not other features included in other embodiments and/or aspects, combinations of features of different embodiments and/or are meant to be within the scope of the invention, and form different embodiments, as would be understood by the skilled person. Features and embodiments for the first or second aspect of the present invention, corresponding to features and embodiments of the second or first aspect of the present invention respectively, are similarly considered to be within the scope of the present invention, as will be recognised by the skilled person.

While the principles of the invention have been set out above in connection with specific embodiments, it is to be clearly understood that this description is merely made by way of example and not as a limitation of the scope of protection which is determined by the appended claims.

1. An internal combustion engine of the four-stroke combustion engine type, comprising an engine block provided with at least one cylinder having a piston movable reciprocally therein for the purpose of bounding a combustion chamber, feed means for air debouching in the combustion chamber, feed means for fuel debouching in the combustion chamber, discharge means for combustion gases connected to the combustion chamber and an ignition mechanism, wherein at least two inlet valves and at least one outlet valve are arranged per cylinder, wherein the feed means for air are connected to the one inlet valve, said air inlet valve, the feed means for a first fuel are connected to the other inlet valve, said fuel inlet valve, and that it is arranged in order to allow mixing of first fuel and air only inside the combustion chamber during operation.

2. The internal combustion engine of claim 1, wherein said ignition mechanism comprises a spark plug.

3. The internal combustion engine of claim 1, wherein the air inlet valve and the fuel inlet valve are separately controlled.

4. The internal combustion engine of claim 1, wherein said at least two inlet valves are coupled to the camshaft.

5. The internal combustion engine of claim 1, wherein the feed means for the first fuel are provided with at least one fuel compartment which is closable by the fuel inlet valve.

6. The internal combustion engine of claim 5, wherein the fuel compartment is connected to a carburettor system or an injector.

7. The internal combustion engine claim 1, wherein feed means for a second fuel are further provided.

8. The internal combustion engine of claim 7, wherein the feed means for the second fuel are connected to the feed means for air.

9. The internal combustion engine of claim 7, wherein the feed means for the second fuel comprise means for direct injection of this second fuel into the combustion chamber.

10. The internal combustion engine of claim 1, wherein the feed means for air comprise at least one injector for air.

11. The internal combustion engine of claim 1, wherein the first fuel is substantially gaseous.

12. The internal combustion engine of claim 11, wherein the first fuel comprises hydrogen gas.

13. The internal combustion engine of claim 11, wherein said first fuel comprises natural gas (CH₄).

14. A method for adapting a four-stroke engine, comprising an engine block provided with at least one cylinder having a piston movable reciprocally therein for the purpose of bounding a combustion chamber, feed means for air debouching in the combustion chamber, feed means for fuel debouching in the combustion chamber, discharge means for combustion gases connected to the combustion chamber and an ignition mechanism, wherein at least two inlet valves and at least one outlet valve are arranged per cylinder, characterized in that it comprises:
arranging said engine in order to have the feed means for air connected to said first inlet valve, and to have the feed means for a first fuel connected to the second inlet valve;
arranging said engine in order to prevent mixing of said first fuel and said air outside the combustion chamber during operation.

15. The method of claim 14, wherein prevention of mixing of said first fuel and said air is achieved by rearranging the coupling of at least the inlet valves with said camshaft.
